(19) United States
(12) Patent Application Publication
(10) Pub. No.: US 2007/0017946 A1
(43) Pub. Date: Jan. 25, 2007

(54) Golf bag fastener

(76) Inventor: Robertson J. Orr, Chandler, AZ (US)

Correspondence Address: LAW OFFICE OF JOHN C. MCMAHON, P.O. BOX 30069, KANSAS CITY, MO, 64112, US

(21) Appl. No.: 11/184,766

(22) Filed: Jul. 19, 2005

(51) Int. Cl. B60R 9/00; B60R 11/00; B60R 7/00

(52) U.S. Cl. 224/274; 224/572

(57) ABSTRACT

An apparatus for releaseably attaching a “stand/carry” golf bag to a riding golf cart includes a pair of fasteners equipped with hook and loop fastening material for attaching a pair of legs of the golf bag stand to a substantially horizontal support of the riding golf cart. Each fastener has a first strip for wrapping about a leg of the golf bag stand. End portions of the first strip overlap, with hook-and-loop fastening material engaging to provide releaseable attachment of the first strip to the golf bag leg. One of the end portions of the first strip preferably includes an adhesive for permanently attaching such end portion to the golf bag leg. A second elongate strip is fixed to the first strip and extends perpendicular thereto. The second strip is configured for wrapping about the horizontal support bar or basket portion of a riding golf cart. The second strip also includes overlapping end portions that are overlapped and engaged by hook-and-loop fastening material to provide for the releaseable fastening of the second strip to the riding golf cart. The second strip further includes a gripping tab extending outwardly therefrom.

### BACKGROUND OF THE INVENTION

The present application relates to attachment and holding apparatus, and in particular, to apparatus for releaseably fastening a golf bag to a riding golf cart.

A variety of golf bags are available for holding golf clubs and other golf accessories. Typically, riding golf carts are designed to cooperate with more traditional, mid sized tour bags, often called “cart” bags that have some rigid structural features. Golf carts typically are designed to include a base platform for supporting a bottom of such a golf bag. The golf cart or the tour bag further includes a strap or straps that are adapted to attach to the golf cart and surround the bag at an upper portion thereof. The straps are buckled or otherwise attached and then cinched about the bag in some manner to hold the bag in place. Such a strapping apparatus that is designed for wrapping and cinching about a body of the bag is effective in holding a typical tour bag to the cart in an upright position. Furthermore, because of the rigid structure of a standard tour bag, the holding strap or straps do not overly squeeze or contract the upper portion of the bag and thus golf clubs may be easily removed and replaced in such a bag that is being held onto a golf cart.

However, if a more light weight “walking” or “hoofer” bag is attached to a golf cart having a base platform and straps designed for holding a standard tour bag, both strangling or squeezing of the upper portion of the walking bag and tipping of the bag often results. A flexible bag that is squeezed or strangled by a holding strap is undesirable because it is difficult to return golf clubs into the bag. Furthermore, tipping or leaning of the narrower, more flexible bags with respect to the golf cart base platform results in difficulty in both removing and returning golf clubs and other items to the bag.

Lighter weight bags that may be carried, and are often identified as “walking” or “hoofer” bags are widely used by golfers because they are lighter, more flexible, often less expensive, easier to carry and easier to transport than a standard tour bag, making them desirable for use with respect to both car and air travel. Most “walking” or “carry” bags are also identified as “stand” bags because they usually include swing out or hinged, v-shaped leg stands that extend outwardly in a tri-pod manner when the bag is placed on the ground, with the bag itself being one leg of the tri-pod. Such “carry/stand” bags are advantageously light to carry during travel and around the golf curse and can advantageously be held upright when placed on the ground. However, as described above, these advantages often become detriments when such bags are attached to golf carts utilizing attachment structure designed for larger, more rigid bags.

### SUMMARY OF THE INVENTION

An apparatus according to the invention for releaseably fastening a golf bag to a riding golf cart is configured for attachment to a pair of legs of a stand of a golf bag. The apparatus includes a pair of releaseable fastening structures, such as hook and loop fastening structures, each structure having a first strip for wrapping about a leg of the golf bag stand. The first strip is of a length such that end portions overlap for attaching the first strap to the golf bag leg. One of the end portions preferably includes an adhesive for permanently attaching such end portion to the leg. A second elongate strip is fixed to the first strip and extends perpendicular thereto. The second strip is for wrapping about a horizontal support bar or basket portion of a riding golf cart. The second strip also is of a length to provide overlapping end portions that when wrapped around the golf cart support bar and thereafter overlapped and engaged, provide for releaseable fastening of the golf bag leg to the riding golf cart.

According to one aspect of the invention, a tab portion is fixed to the second strip at one of the overlapping ends. The tab portion is disposed perpendicular to the second strip and extends outwardly on either side of the second strip. The tab portion provides a gripping surface for a user to grasp or press when wrapping the second strip about the golf cart support bar and joining overlapping portions of the second strip to one another.

### OBJECTS OF THE INVENTION

Therefore, objects of the present invention include: providing a releaseable holding or fastening apparatus for attaching a golf bag having a stand to a golf cart; providing such an apparatus that firmly attaches the golf bag to the golf cart without constricting the bag; providing such an apparatus that holds a golf bag on a golf cart in a substantially vertical position; providing such an apparatus that is inexpensive to produce and especially well adapted for the intended usage thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWING

FIG. 1 is a perspective view of a first (hook) side of a fastener according to the invention.

FIG. 2 is perspective view of a second (loop) side of the fastener of FIG. 1.

FIG. 3 is a reduced perspective view of a golf cart and a golf bag having a pair of legs attached to the golf cart with fasteners according to FIG. 1.

FIG. 4 is an enlarged and partial perspective view showing the fastener of FIG. 1 during installation to a leg of a walking golf bag.

FIG. 5 is an enlarged and partial perspective view similar to FIG. 4 showing the fastener of FIG. 1 fully installed on the leg of the walking golf bag.

FIG. 6 is an enlarged and partial view of the golf cart, golf bag and golf bag legs shown in FIG. 3, showing a pair of fasteners of FIG. 1 already attached to the golf bag legs further being attached to the golf cart with a user's hands included to show installment thereof.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

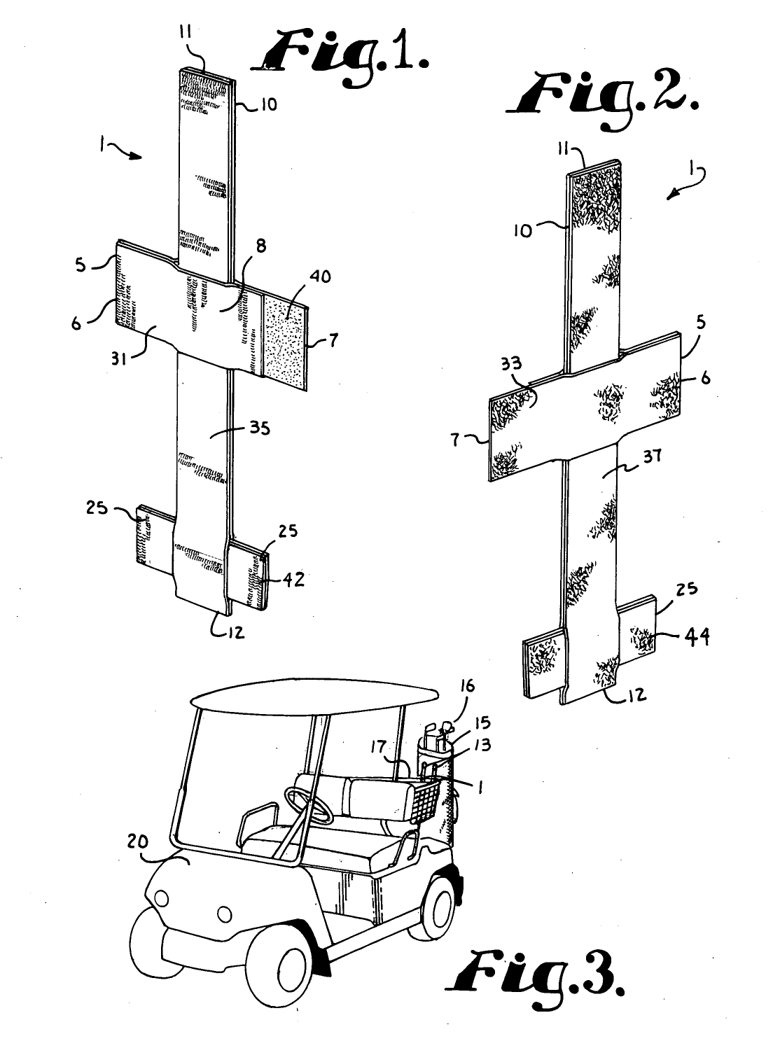

With reference to FIGS. 1-6, the reference numeral 1 generally designates a golf bag fastener according to the invention. Specifically, the fastener 1 is for releaseably fastening a golf bag to a riding golf cart. The fastener 1 includes a first strip or strap 5 having first and second ends 6 and 7 and a middle or central portion 8 fixed to a second elongate strip or strap 10. The strap 10 includes a first or upper end 11 and a second or lower end 12. The first strip 5 is disposed substantially perpendicular to the second strip 10. The strips 5 and 10 are adhesively fixed or otherwise attached to one another substantially midway between the upper end 11 and the lower end 12 of the strip 10. Although first and second strips 5 and 10 are illustrated in the drawings, it is foreseen that a fastener according to the invention could be made from four or more separate pieces fixed to one another. Alternatively, the fastener 1 may be made from a single sheet of material, with the strips 5 and 10 being integral as described more fully below.

The first strip 5 is sized for extending about one of a pair of legs 13 of a stand of a golf bag 15 for carrying clubs 16, often identified as a “walking” or “carry/stand” golf bag. The strip 10 is sized to extend about a horizontal support 17 of a riding golf cart 20. Because the support 17 is typically larger than the legs 12, the second strip 10 is illustrated as longer than the strip 5. In the illustrated embodiment, the strip 5 is approximately two inches (5.1 cm) in width and five inches (12.7 cm) in length and the strip 10 is approximately one inch (2.54 cm) in width and nine inches (22.9 cm) in length. Also in the illustrated embodiment, a holding tab 25 may be included that is disposed perpendicular to the second strip 10 and is attached to the second strip 10 near the lower end 12 thereof. It is noted that the reference to the words top and bottom, upper and lower, and the like, as used herein refers to the alignment shown in the various drawings, as well as the normal connotations applied thereto, and is not intended to restrict positioning of the fastener 1 in actual use.

As illustrated in FIGS. 1 and 2, the strip 5 includes a front or forward surface 31 and a back or rear surface 33. The strip 10 also includes a front or forward surface 35 and a back or rear surface 37. The front surfaces 31 and 35 are substantially covered with the “hook” component of a hook-and-loop fastening material commonly sold under the registered trademark VELCRO. The back surfaces 33 and 37 are substantially covered with the “loop” component of the hook-and-loop fastening material. The strip 5 at the surface 31 further includes an end portion 40 disposed near the end 7 that has a permanent adhesive, such as a pressure adhesive, thereon. As will be described more fully below, the portion 40 provides for permanent adhesion of the fastener 1 to one of the legs 13 of the golf bag 15. Although the illustrated embodiment shows hook-and-loop fastening material entirely covering each side of the strip 10 and substantially covering both sides of the strip 5, it is foreseen that releaseable fasteners according to the invention may include hook-and-loop material only at overlapping portions near the ends 6, 7, 11 and 12. Furthermore, it is foreseen that other types of releaseable fasteners, including snaps, buckles, hooks, releaseable adhesives, and the like may be used instead of the illustrated hook-and-loop fastening material.

The holding tab 25 extends outwardly substantially equally on either side of the strip 10. The illustrated tab 25 includes a front surface 42 and a rear surface 44 with the front surface 42 shown having the “hook” of a hook-and-loop fastening material and the rear surface 44 having the “loop” of a hook-and-loop fastening material. It is not necessary to make the tab 25 from hook-and-loop material as the tab 25 is not used for attachment, but rather for a gripping surface. The hook-and-loop fastening material provides a roughened surface that is advantageous for gripping purposes, but the surfaces 42 and 44 may be smooth or otherwise roughened to aid in gripping. The fastener 1 may be made from a single sheet of double sided hook-and-loop fastening material (hook on one side and loop on the other), with a single die stamp being used for cutting the fastener shape. In such case, the tab 25, if included, would also be made from the hook-and-loop fastening material as shown.

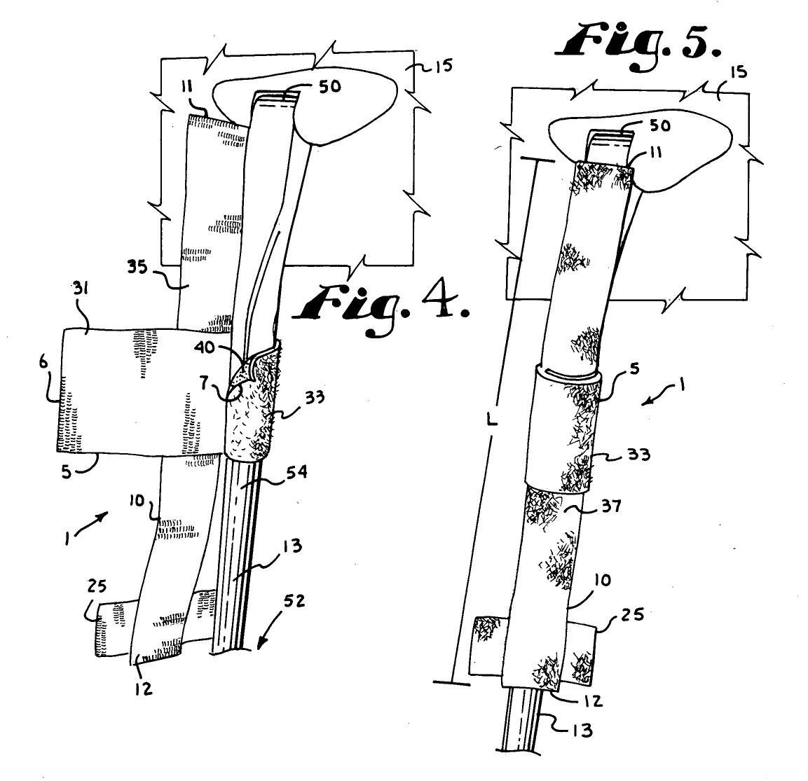

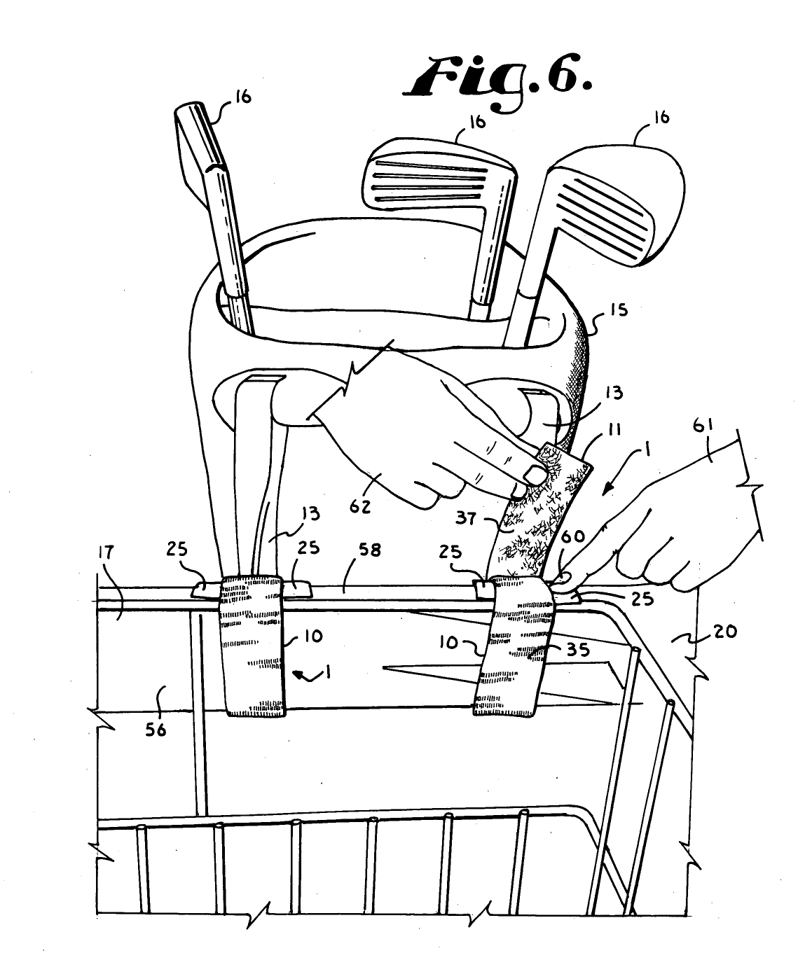

In use, a pair of fasteners 1 are first attached to a pair of legs 13 of the golf bag 15 as illustrated in FIGS. 4 and 5. A fastener 1 is placed next to a leg 13 with the front or hook side 31 facing the leg 13, the upper end 11 near an upper end 50 of the leg 13 and the holding tab 25 directed toward a lower portion, generally 52 of the leg 13. The strip 5 is first attached to the leg 13 by positioning the end 7 and the adjacent adhesive portion 40 on the leg 13 in such a manner that when wrapped about the leg 13, the central portion 8 of the strip 5 and an entire length of the strip 10 covers a length L of a front portion 54 of the leg 13 facing away from the bag 15. After the adhesive portion 40 is pressed against the leg 13, the remainder of the strip 5 is wrapped about the strip portion 40 and around the leg 13 with the hook surface 31 attaching to the loop surface 33 and the end 6 overlapping the end 7 as illustrated in FIG. 5. Also as illustrated in FIG. 5, the loop surfaces 33 and 37 of the strips 5 and 10 respectively are facing outwardly away from the leg 13. A second fastener 1 is similarly attached to a second leg 13 of the golf bag 15.

With reference to FIG. 6, the golf bag 15 with an attached pair of fasteners 1 is then attached to the horizontal support 17 of the riding golf cart 20 by placing the golf bag 15 on a rear support (not shown) of the golf cart 20 with the legs 13 facing the support 17. The tab 25 and/or the lower end 12 of one of the fasteners 1 is then grasped, moved upwardly and positioned about a front 56 of the support until the holding tab 25 is preferably positioned at or near a top 58 of the support. The tab 25 may then be pressed against the top 58 by a user's finger 60 or fingers of one hand 61 while the user's other hand 62 grasps the strip 10 near the end 11 and moves the strip 10 downward over the end 12 in an overlapping manner, with the loop side 37 being brought down and into contact with the hook side 35 of the strip 10. In like manner, the second fastener 1 is wrapped about and releaseably attached to the support 17. FIG. 6 illustrated both a fully installed fastener 1 and a fastener 1 in the process of being installed.

To remove the fastener 1, a user may press against the tab 25 and pull the end 11 of the strip 10 up and away from the remainder of the strip 10, detaching the hook-and-loop fasteners. After both fasteners 1 are detached in such manner, the bag 15 may be moved away from the cart 20. The fasteners 1 advantageously remain attached to the legs 13 of the bag 15 for future use. The fasteners 1 may also be used to store the golf bag 15 on a horizontal support that is mounted in a garage or other storage space.

It is to be understood that while certain forms of the present invention have been illustrated and described herein, it is not to be limited to the specific forms or arrangement of parts described and shown.

What is claimed and desired to be secured by Letters Patent is as follows:

1. An apparatus for fastening a golf bag to a horizontal support, the golf bag having a stand with a pair of legs, the apparatus comprising:
a) a first strip having first and second end portions and having a first length configured for wrapping about a substantially vertically extending leg of a golf bag stand and overlapping the first and second end portions, the overlapping first and second end portions having respective first and second cooperating releaseable attachment structure thereon; and
b) a second strip disposed perpendicular to the first strip and fixed thereto, the second strip having third and fourth end portions and a second length configured for wrapping about a horizontal support and overlapping at the third and fourth end portions, the overlapping third and fourth end portions having respective third and fourth cooperating releaseable attachment structure thereon.

2. The apparatus of claim 1 wherein the fourth end portion is a lower end portion and further comprising a holding tab disposed perpendicular to the second strip and attached thereto at the lower end portion, the tab extending substantially horizontally on either side of the second strip.

3. The apparatus of claim 1 wherein the releaseable attachment structure is hook-and-loop fastening material.

4. The apparatus of claim 3 wherein the first and third overlapping end portions have a hook material thereon and the second and fourth portions have a loop material thereon.

5. The apparatus of claim 1 wherein the first strip includes an adhesive portion for permanent attachment of the first strip to a leg of the golf bag.

6. A fastener comprising:
a) a first elongate strip having a hook feature of a hook-and-loop fastener on a first side thereof and a loop feature of a hook-and-loop fastener on a second side thereof, the first strip having a first length for extending about and releaseably attaching in overlapping manner to a substantially vertical support of a first item;
b) a second elongate strip centrally fixed to the first strip and disposed perpendicular thereto, the second strip having a second length for extending about and releaseably attaching in overlapping manner to a substantially horizontal support of a second item, the second strip having a hook feature of a hook-and-loop fastener on a third side thereof and a loop feature of a hook-and-loop fastener on a fourth side thereof, the first and third sides facing a first direction and the second and fourth sides facing an opposite direction when the fastener is in a flat unengaged position; and
c) a gripping strip disposed near an end of the second strip and fixed thereto, the gripping strip extending outwardly in a direction perpendicular to the second strip and located and configured for pressing against the horizontal support during wrapping of the second strip about the horizontal support.

7. The fastener of claim 6 wherein the first strip includes an adhesive portion for permanent attachment of the first strip to the vertical support.

8. A kit for fastening a “carry/stand” type golf bag to a horizontal support of a golf cart, the golf bag having a stand with a pair of legs, the kit comprising:
a) a pair of fasteners, each fastener further comprising:
i) a first elongate strip having a hook feature of a hook-and-loop fastener on a first side thereof and a loop feature of a hook-and-loop fastener on a second side thereof, the first strip having a first length for extending about in overlapping manner a substantially vertically extending leg of a golf bag, the first side further having a permanent adhesive on a portion thereof for permanently fixing the first strip to the golf bag leg;
ii) a second elongate strip fixed to the first strip at a location central to both the first and second strips, the second strip disposed perpendicular to the first strip, the second strip having a second length for extending about in overlapping manner a substantially horizontal support of a golf cart, the second strip having a hook feature of a hook-and-loop fastener on a third side thereof and a loop feature of a hook-and-loop fastener on a fourth side thereof, the first and third sides facing a first direction and the second and fourth sides facing an opposite direction when the fastener is in a flat unengaged position; and
iii) a gripping tab disposed near a lower end of the second strip and fixed perpendicular thereto, the gripping tab extending on either side of the second strip and located and configured for pressing against the horizontal support during wrapping of the second strip about the horizontal support.
